(19) United States
(12) Patent Application Publication
(10) Pub. No.: US 2017/0074405 A1
(43) Pub. Date: Mar. 16, 2017

(54) SEALING ELEMENT, SEALING SYSTEM WITH A SEALING ELEMENT, TURBOMACHINE WITH A SEALING SYSTEM AND METHOD FOR MANUFACTURING A SEALING ELEMENT

(71) Applicant: Rolls-Royce Deutschland Ltd & Co KG, Blankenfelde-Mahlow (DE)

(72) Inventors: Miklos GAEBLER, Potsdam (DE); Stephan PANNIER, Nuthetal (DE)

(21) Appl. No.: 15/263,853

(22) Filed: Sep. 13, 2016

(30) Foreign Application Priority Data
Sep. 15, 2015 (DE) 10 2015 217 670.3

(51) Int. Cl. F16J 15/453; F01D 11/00; F01D 11/02; F16J 15/447

(52) U.S. Cl. CPC F16J 15/453; F16J 15/447; F01D 11/003; F01D 11/02; F05D 2220/323; F05D 2300/177; F05D 2300/2262; F05D 2230/30

(57) ABSTRACT

A sealing element for a rotating sealing system of a turbomachine is provided. The sealing element, if installed in the sealing system according to the intended use, can be rotated around a rotational axis of the turbomachine. The sealing element comprises a ring-shaped sealing lip that has a central point through which the rotational axis extends if the sealing element is installed in the sealing system according to the intended use, wherein the sealing lip has at least one recess, and at least one rubbing element that is arranged at the sealing lip, wherein the at least one rubbing element is arranged inside the at least one recess and projects at least partially beyond the outer contour of the sealing lip in the radial and/or the axial direction with respect to the rotational axis. The at least one rubbing element has a plurality of layers of a rubbing material.

### REFERENCE TO RELATED APPLICATION

This application claims priority to German Patent Application No. 10 2015 217 670.3 filed on Sep. 15, 2015, the entirety of which is incorporated by reference herein.

### BACKGROUND

The invention relates to a sealing element, a sealing system for a turbomachine, a turbomachine with a sealing system and a method for manufacturing a sealing element.

What is known from EP 1 114 241 B1 is a sealing element for a rotating fluid seal, wherein the sealing element has a sealing lip. A rubbing element is arranged in at least one location of the sealing lip in such a manner that the rubbing element projects radially and on one or two sides axially beyond the outer contour of the sealing lip. The rubbing element is a preformed element that is connected to the sealing lip in a form-fit and/or firmly bonded manner.

US 2007/0110562 A1 discloses a sealing element for a labyrinth seal that comprises a sealing lip and a plurality of U-shaped staples. The staples are arranged inside recesses at the sealing lip of the sealing element, so that they at least partially project beyond the outer contour of the sealing lip and form rubbing elements. Here, too, the rubbing elements are preformed elements that are connected to the sealing lip.

If installed in a sealing system according to the intended use, the sealing elements can come into contact at least partially with a run-in coating and therefore be subjected to high loads. These can be thermal loads as well as mechanical loads.

Especially a sealing lip of a sealing element is subject to these high loads. Excessive thermal and/or mechanical loads may result in the formation of cracks in the sealing lip.

It is therefore necessary to protect the sealing element, in particular the sealing lip, from these loads. This may for example be achieved by avoiding any large-area contact of the sealing lip with the run-in coating. In the state of the art, this is realized by arranging at least one rubbing element at the sealing lip, which facilitates broaching the run-in coating.

By broaching the run-in coating with the at least one rubbing element, the load on the entire sealing lip is reduced. It is mainly the rubbing element that comes into contact with the run-in coating; the sealing lip itself does not, for the most part. In this way, especially the rubbing element is subjected to high loads.

The rubbing elements that are known from the state of the art are arranged at the sealing lip in order to create a maximally effective abrasion effect if the sealing element is used in a sealing system and comes into contact with a run-in coating. Here, the abrasion effect is mainly created by the geometrical outer contour of the rubbing elements. Moreover, the rubbing elements have to be present in a prefabricated form before they can be connected to the sealing lip.

### SUMMARY

The present invention is based on the objective to provide a sealing element, a sealing system for a turbomachine, a turbomachine with a sealing system and a method for manufacturing a sealing element which are easy to manufacture and easy to use.

According to the invention, this objective is achieved through a sealing element with the features as described herein, a sealing system for a turbomachine with the features as described herein, a turbomachine with a sealing system with the features as described herein, and a method for manufacturing a sealing element with the features as described herein.

If installed in the sealing system of the turbomachine according to the intended use, the sealing element can be rotated around a rotational axis of the turbomachine. Here, the sealing element comprises a ring-shaped sealing lip, which can for example be configured in a circular manner. The ring-shaped sealing lip has a central point through which the rotational axis of the turbomachine extends if the sealing element is installed in the sealing system according to the intended use. Thus, the sealing element can rotate around the rotational axis of the turbomachine.

At least one recess is introduced into the sealing lip, with the at least one rubbing element being arranged therein. The rubbing element can for example be formed at the sealing lip itself. Here, the at least one rubbing element projects at least partially beyond the outer contour of the sealing lip, and namely in the axial direction, that is, along the rotational axis and/or in the radial direction, that is, perpendicular to the rotational axis of the turbomachine. The at least one rubbing element further has a plurality of layers of a rubbing material that comprises at least one basic material and abrasion particles. The abrasion particles are intermixed with the basic material. The abrasion particles and the basic material can have an increased thermal and mechanical resistance as compared to the rest of the material of the sealing element.

Further, the layers of the at least one rubbing element are configured at least partially in such a manner that the axial extension of the layers decreases with growing distance from the central point of the sealing lip. Thus, the at least one rubbing element at least in certain sections has an outer contour which tapers off in a cross-section in a convergent manner perpendicular to the circumferential direction of the sealing element. The layers project axially beyond the outer contour of the sealing lip, so that the layers form a contour at the exterior side. This structure can have an abrasive effect, for example.

In this way, it is possible to arrange the rubbing material at the sealing lip and thus form at least one rubbing element in a simple manner. The at least one rubbing element does not have to be present in the form of a prefabricated structural component, but can be formed at the sealing lip. In addition, the abrasion effect of the at least one rubbing element is increased through the composition of the rubbing material, comprising the basic material which is provided with abrasion particles. The surface of the at least one rubbing element does not undergo any further processing following the arrangement at the sealing lip. In this manner, a rough surface is created, in particular due to the layered configuration of the at least one rubbing element and/or due to the composition of the rubbing material.

As has already been described in the beginning, the sealing element—if installed according to the intended use in a sealing system—can come into contact at least partially with a static run-in coating and therefore be subjected to high loads. Through this rubbing element, these loads on the sealing lip of the sealing element can be reduced, since the contact surface of the sealing lip and the static run-in coating is reduced, for example by means of broaching the static run-in coating with the rubbing element. An increased abrasion effect of the rubbing element can facilitate the broaching of the static run-in coating.

What is understood by an abrasion effect is that—if the sealing element is installed according to the intended use in the sealing system—the at least one rubbing element creates abrasion in the static run-in coating that is arranged opposite to the sealing element in the radial direction. In this way, the static run-in coating is at least partially broached and the load on the other areas of the sealing element is reduced.

It is possible that the sealing lip has at least one recess, which is for example formed by a milling groove of the sealing lip, in order to receive the at least one rubbing element that is formed in a layered manner at least partially or completely inside the recess.

In another embodiment variant, the extension of at least some layers decreases along the circumferential direction with growing distance from the central point. In this manner, a convergent outer contour of the at least one rubbing element is created at least in certain sections in a cross-section perpendicular to the rotational axis.

In a further development, the at least one rubbing element has a separation layer for connecting to the sealing lip in order to facilitate a separation of the rubbing element from the sealing lip. In this way, a decoupling of the two elements can be achieved.

According to further embodiment variants, the at least one rubbing element can have a varying height along the circumferential direction of the sealing lip and/or can project at least partially beyond an outer contour of the sealing lip at least partially only on one side of the sealing lip along the axial direction.

In a further embodiment it is possible that the at least one rubbing element projects at least partially beyond the outer contour of the sealing lip in the axial direction only on one side of the sealing lip. Additionally or alternatively it is also possible that the surface of the at least one rubbing element is not subjected to any further processing following the arrangement at the sealing lip.

These configurations of the at least one rubbing element can increase the abrasion effect of the at least one rubbing element. In one embodiment variant, the abrasion effect can also be controlled in a targeted manner by means of the geometrical configuration of the rubbing element. In this way, it is possible to not only adjust the strength of the abrasion effect of the at least one rubbing element, but also the shape of the broached area of the run-in coating, such as for example the depth and/or the spatial orientation of the abrasion.

In a further embodiment, the rubbing material is arranged at the sealing lip by means of laser deposition welding (DLD, direct laser deposition). The laser deposition welding makes it possible to create local melting areas, for example in the sealing lip, into which the rubbing material can be introduced, for example in powder form, in order to connect the rubbing material with the sealing lip in a firmly bonded manner. It is also possible to create local melting areas in areas of the sealing element, in which rubbing material has already been arranged at the sealing lip, and to connect additional rubbing material in a firmly bonded to the already present rubbing material and thus to the sealing lip.

In one embodiment, the basic material of the rubbing material is the same as the material of the sealing lip either to a substantial percentage or completely. In particular, the basic material as well as the material of the sealing lip can be formed from a nickel-based alloy either to a substantial percentage or completely. In this manner, the arrangement of the rubbing material at the sealing lip can be facilitated. In one embodiment variant, the basic material can contain Inco718, Inco718+, Udimet, Waspaloy and/or RR1000, or can be comprised completely of these materials.

Further, the basic material can contain a nickel-based alloy, in particular 720Li, or can be comprised completely thereof. Details on such an 720Li alloy can be gathered from the following document: “Tensile Properties of Ni-Based Superalloy 720Li: Temperature and Strain Rate Effects” by K. Gopinath et al., Metallurgical and Materials Transactions A, Volume 39, No. 10, pages 2340-2350, DOI: 10.1007/s11661-008-9585-3.

In one embodiment variant, the abrasion particles are formed in a sharp-edged manner and/or have an increased hardness as compared to the basic material, in particular the abrasion particles can comprise materials of metal, ceramics and/or carbide. Thus, in a further development, the abrasion particles comprise cBN and/or TiC particles, for example.

The sharp-edged and/or hard abrasion particles facilitate broaching of the run-in coating.

In a further embodiment, the sealing lip can have multiple rubbing elements, which are for example arranged in a symmetrical manner along the circumference of the sealing lip. Thus, for example three rubbing elements can be arranged along the circumference of the sealing lip in such a manner that they are offset by respectively 120°, or four rubbing elements can be arranged along the circumference of the sealing lip in such a manner that they are offset by respectively 90°.

In one embodiment, the sealing lip can also have at least one groove at is circumference that is arranged at least in a substantially radial manner, in particular with grooves in the form of micro-slits having a width of between 50 μm and 300 μm. These grooves particularly serve the purpose of reducing thermal stress.

The objective is also achieved by a sealing system for a turbomachine with the features as described herein.

One embodiment of the sealing system has a static run-in coating, which is arranged opposite the at least one sealing element in the radial direction. Here, the at least one rubbing element of the at least one sealing element comes into contact with the static run-in coating during operation of the sealing system. Here, the at least one rubbing element broaches the static run-in coating at least partially. It is possible that the rubbing element comes into contact with the run-in coating as the first or as the only element of the sealing system.

In one embodiment variant, the sealing system can be formed as a labyrinth seal, in particular for an aircraft engine.

The objective is also achieved through a turbomachine, in particular an aircraft engine with the features as described herein.

The objective is also achieved through a method with the features as described herein, wherein the method comprises the following steps:
a) providing a sealing lip;
b) introducing at least one recess into the sealing lip, in particular by milling it out;
c) localized melting of the at least one recess (i.e. of the sealing lip material), for example by using a laser;
d) introducing a powdery rubbing material, comprising a basic material intermixed with abrasion particles, into the locally melted area of the recess and creating an area with an increased thickness;
e) repeating the steps c) and d) until a first layer of the at least one rubbing element is formed in the at least one recess. In particular, this first layer can serve as a separation layer;
f) localized melting of an already formed layer of the at least one rubbing element inside the at least one recess, in particular with a laser;
g) introducing the powdery rubbing material into the melted area and thus creating an area with an increased thickness;
h) repeating the steps f) and g) until another layer of the at least one rubbing element is formed in the at least one recess, which comprises the rubbing material;
i) repeating step h) until the rubbing element is built up from successive layers that comprise the rubbing material;

### BRIEF DESCRIPTION OF THE DRAWINGS

Exemplary embodiments are explained based on the following description and the Figures.

FIG. 1A shows a rendering in principle of a first embodiment of a sealing element with a rubbing element.

FIG. 1B shows a rendering in principle of a second embodiment of a sealing element with three rubbing elements.

FIG. 1C shows a rendering in principle of a third embodiment of a sealing element with four rubbing elements.

FIG. 2A shows an exemplary embodiment of a sealing element with a rubbing element that is built up by layers.

FIG. 2B shows the exemplary embodiment of FIG. 2A in a cross-section perpendicular to the circumferential direction along the plane A-A of FIG. 2A.

FIG. 2C shows the exemplary embodiment of FIG. 2A in a cross-section perpendicular to the circumferential direction along the plane B-B of FIG. 2A.

FIG. 3A shows a further exemplary embodiment of a sealing element with a rubbing element that is built up by layers.

FIG. 3B shows the exemplary embodiment of FIG. 2A in a cross-section perpendicular to the circumferential direction along the plane A-A of FIG. 2A.

FIG. 3C shows the exemplary embodiment of FIG. 2A in a cross-section perpendicular to the circumferential direction along the plane B-B of FIG. 2A.

FIG. 3D shows the exemplary embodiment of FIG. 2A in a cross-section perpendicular to the circumferential direction along the plane C-C of FIG. 2A.

FIG. 4 shows a further embodiment variant of a sealing element with at least one rubbing element in a cross-section perpendicular to the circumferential direction.

FIGS. 5A to 5C show three different states during the formation of a rubbing element that is built up by layers at a sealing lip in perspective view.

FIGS. 6A to 6D show four different geometrical embodiment variants of the at least one rubbing element.

FIG. 7 shows an embodiment of a sealing lip with a groove, in particular for reducing thermal stress.

### DETAILED DESCRIPTION

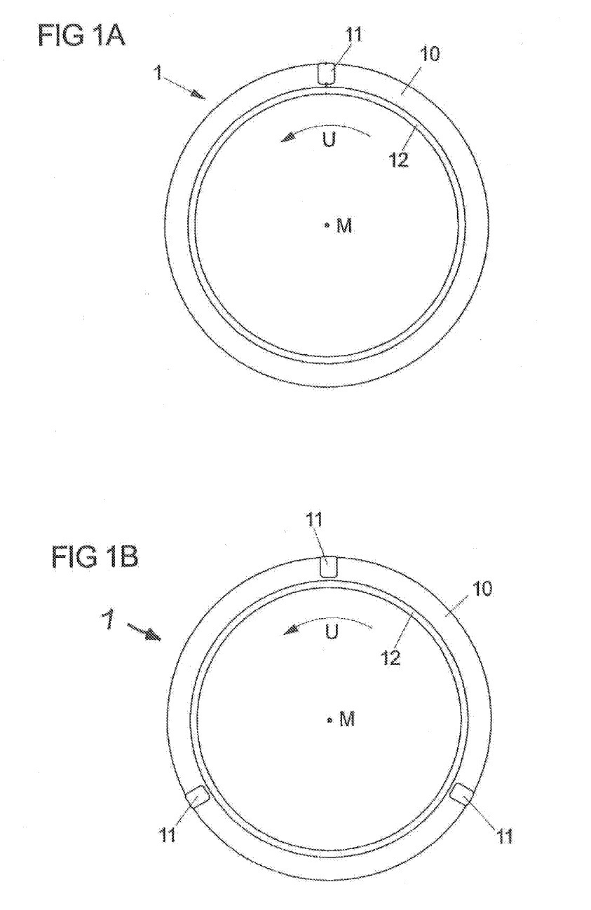

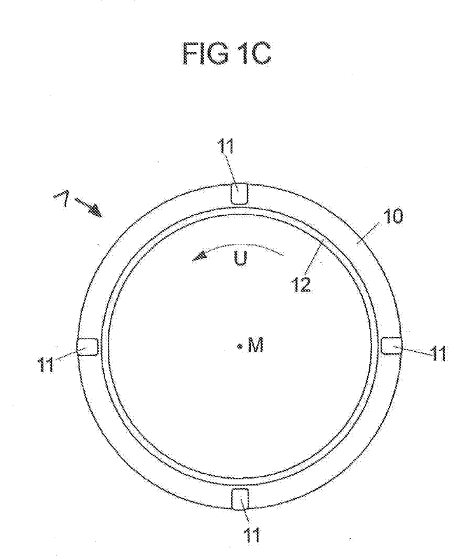

FIG. 1A shows the arrangement in principle of an exemplary embodiment of a sealing element 1. The sealing element 1 comprises a ring-shaped sealing lip 10 that is connected to the ring-shaped base 12. At that, the ring-shaped base 12 and the ring-shaped sealing lip 10 are formed in a circular manner and have a common central point M, with the base 12 being arranged inside the sealing lip 10.

If the sealing element is installed in a sealing system of a turbomachine according to the intended use, the rotational axis of the turbomachine extends through the central point M perpendicular with respect to the image plane. Here, the rotational axis defines an axial direction. The radial direction extends perpendicularly with respect to the rotational axis. In the following, all directional specifications refer to an installation of the sealing element in a sealing system of a turbomachine according to the intended use.

What is further defined is a circumferential direction U that extends in a counterclockwise manner along the movement direction of the sealing element 1, in the case of installation in the sealing system according to the intended use and during operation of the sealing system. In principle, it is also possible for the rotational direction to be defined in the opposite direction.

In the embodiment according to FIG. 1A, a rubbing element 11 is arranged at the sealing lip 10. FIGS. 1B and 1C show further exemplary embodiments of a sealing element 1. They differ from the exemplary embodiment in FIG. 1A in the fact that they have a plurality of rubbing elements 11. In the embodiment according to FIG. 1B, three rubbing elements 11 are arranged at the sealing lip 10 in such a manner that they are offset by respectively 120°.

In the embodiment according to FIG. 1C, four rubbing elements 11 are arranged at the sealing lip 10 in such a manner that they are offset by respectively 90°.

In exemplary embodiments that are not shown here, also two or more than four rubbing elements 11 can be arranged at the sealing lip 10, wherein the arrangement can be rotationally symmetrical or asymmetrical.

In FIG. 1A and also in the further renderings, the sealing lip 10 is arranged in such a manner that the sealing effect unfolds radially outward. However, in principle it is also possible for the sealing lip 10 to unfold its sealing effect radially inwards.

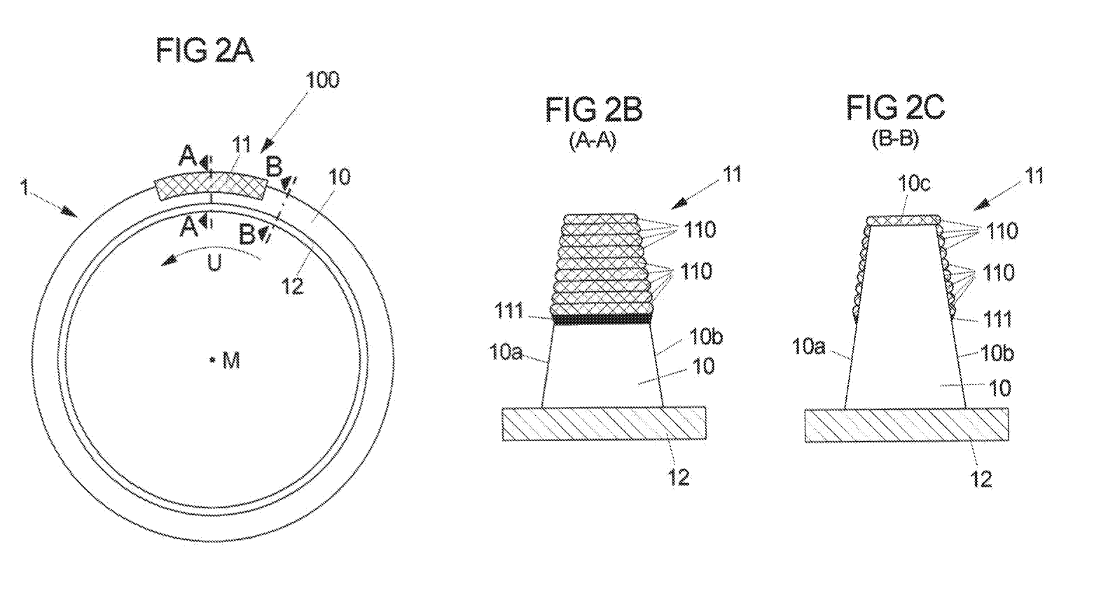

FIGS. 2A, 2B and 2C show an exemplary embodiment of the sealing element 1, which can for example be arranged according to FIG. 1A, 1B or 1C.

Here, the rubbing element 11 is arranged inside a recess 100 of the sealing lip 10. The rubbing element 11 projects at least partially beyond the outer contour of the sealing lip 10, radially as well as on both sides axially. FIG. 2B shows a cross-section perpendicular to the circumferential direction U along the plane A-A of FIG. 2A, and FIG. 2C shows a cross-section perpendicular to the circumferential direction U along the plane B-B of FIG. 2A. The plane A-A extends radially and centrally through the rubbing element 11. The plane B-B extends radially and through an area of the sealing lip 10 that is located outside of the rubbing element 11, and namely along the circumferential direction U a short distance in front of the rubbing element 11.

In the cross-section perpendicular to the circumferential direction U, the sealing lip 10 has an isosceles, symmetrical, trapezoid-shaped contour, wherein the two side legs 10a, 10b taper off in the radial direction with growing distance from the central point M, that is, they form a convergent outer contour.

The bottom side of the sealing lip 10 is formed by the base 12 of the sealing element 1, wherein the base 12 with its rectangular cross-section has a larger extension in the axial direction than the sealing lip 10. The top side 10c of the sealing lip 10 extends in parallel to the base 12.

FIG. 2C shows once more that the rubbing element 11 projects beyond the outer contour of the sealing lip 10.

The recess 100 is formed as a milling groove of the sealing lip 10. It removes a part of the sealing lip material, but does not extend all the way up to the base 12 of the sealing element 1. All of the following exemplary embodiments also have the same structure of the sealing lip and the base, and the recesses 100 are also formed just like in this exemplary embodiment. However, in principle also other geometrical arrangements are possible.

The rubbing element 11 has multiple layers 110 made of rubbing material, wherein the rubbing material has a basic material G that is provided with abrasion particles P.

The first layer of the rubbing element 11, which is connected to the sealing lip 10, can form a separation layer 111. The separation layer 111 can decouple the rubbing element 11 from the sealing lip 10.

This separation layer 111 is followed by multiple layers 110, which become smaller in their axial extension with increasing radial distance from the central point M. What is created in this manner is a trapezoid outer contour of the rubbing element 11 that tapers off at least in certain sections.

Here, the layers 110, 111 of the rubbing element 11 axially project beyond the outer contour of the sealing lip 10 on both sides. In the radial direction, the rubbing element 11 has such a number of layers 110 of a corresponding thickness that at least one layer projects partially beyond the outer contour of the sealing lip 10 in the radial direction.

In some exemplary embodiments, the first layer of the rubbing element 11 can be formed identically to the further layers 110 of the rubbing element 11.

The layers 110, 111 of the rubbing element 11 are firmly bonded to each other and to the sealing lip 10 by means of laser deposition welding of the rubbing material. Unless otherwise specified, this also applies to all other exemplary embodiments with a layered structure of the rubbing element 11.

Since the surface of the rubbing element 11 has not been subjected to any further processing following the arrangement at the sealing lip 10 inside the recess 100, it has a roughness which in particular results from the layered structure and the abrasion particles P. None of the irregularities at the surface of the rubbing element 11, which result from the arrangement of the rubbing element 11 at the sealing lip 10, are subsequently corrected.

The abrasion particles P are sharp-edged particles that have an increased hardness as compared to the basic material G. Abrasion particles P can comprise cBN particles and/or TiC particles, for example.

Here and also in the following, the abrasion particles P are shown only in a symbolic manner and can take diverse regular as well as irregular shapes, in particular arbitrary geometrical shapes. It can also be assumed that in the following exemplary embodiments the rubbing element 11 has never undergone any post-processing, in particular of its surface, after it has been arrangement at the sealing lip 10.

Here, the basic material can consist of the same material as the sealing lip 10. The basic material G may contain a nickel-based alloy, such as for example Inco718, Inco718+, Udimet, Waspaloy and/or RR1000, or can consist completely of these alloys.

The composition of the rubbing material from a basic material that is intermixed with abrasion particles P may result in an increased abrasion effect of the rubbing element 11, especially due to the abrasion particles P. The rough areas on the surface of the rubbing element 11, which are created during the arrangement of the rubbing element 11 at the sealing lip 10, can also lead to an increased abrasion effect.

Due to the fact that the rubbing element 11 projects at least partially beyond the outer contour of the sealing lip 10, a run-in coating (which is not shown here) can be at least partially broached by the rubbing element 11 if the sealing element is installed in a sealing system according to the intended use, so that the sealing lip 10 itself hardly comes into contact or even does not come into contact at all with the run-in coating.

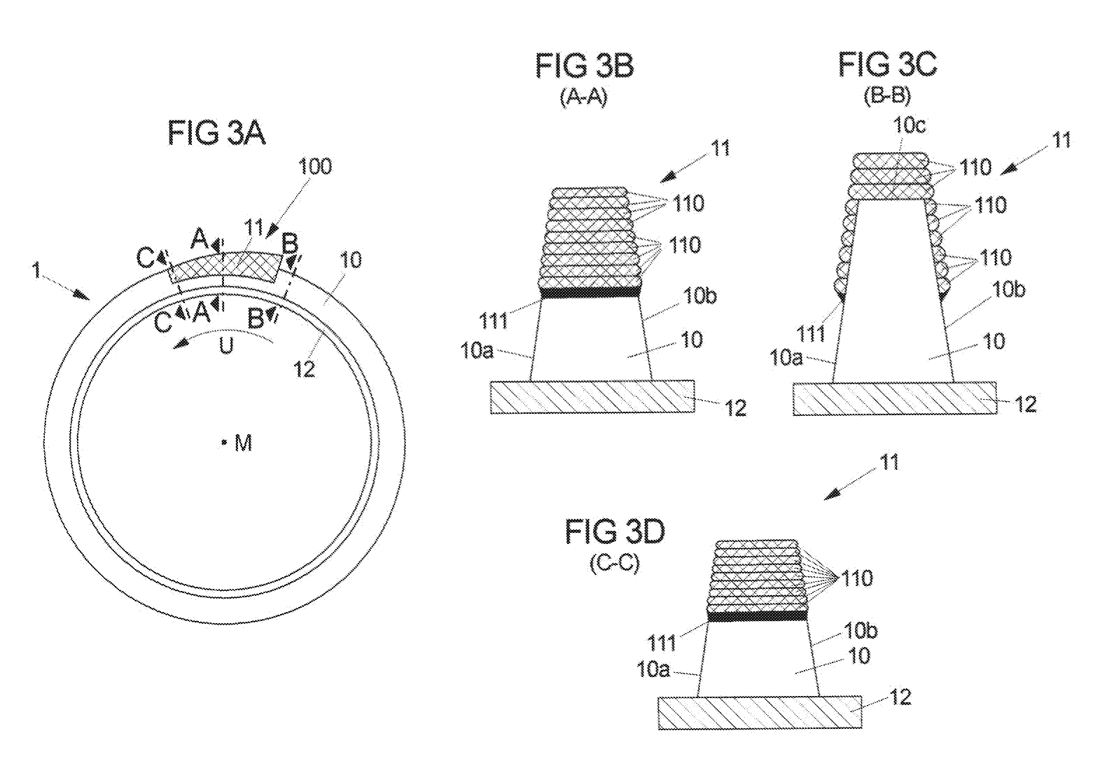

FIGS. 3A to 3D show an embodiment variant of the sealing element 1, in which the rubbing element 11 is a variation on the embodiment variant according to FIGS. 2A to 2C. In principle, it may be referred to the description of FIGS. 2A to 2C. Thus, in particular the sectional planes A-A and B-B are chosen like in FIG. 2A.

FIG. 3D shows a cross-section along the sectional plane C-C of FIG. 3A. The sectional plane C-C extends through the rubbing element 11, but at its outer left edge (see FIG. 3A).

The rubbing element 11 projects beyond the outer contour of the sealing lip 10 in the axial as well as in the radial direction.

A difference to the embodiment variant according to FIGS. 2A to 2C is the fact that the rubbing element 11 has a varying radial height along the circumferential direction U. Here, the radial height of the rubbing element 11 decreases (see e.g. FIG. 3A) along the circumferential direction U.

Another difference is that the layers 110 of the rubbing element 11 have a varying extension along the circumferential direction U also in the axial direction. Thus, the axial extension of the layers 110 decreases within each layer 110 along the circumferential direction U.

Also, the axial extension of the different layers 110 decreases from layer to layer in a manner analogous to the previous embodiment variant of FIGS. 2A to 2C with increasing radial distance from the central point M. Again, the rubbing element 11 also has a separation layer 111 that separates the other layers 110 from the sealing lip 10.

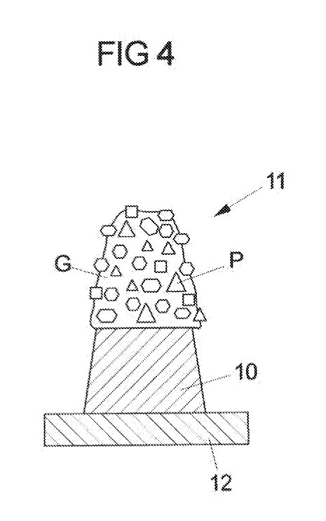

In FIG. 4, a cross-section perpendicular to the circumferential direction U through a sealing element 1 in the area of at least one rubbing element 11 is shown, for example. Here, the rubbing element 11 is arranged inside a recess 100 of the sealing lip 10, which is not visible here. The rubbing element 11 consists of a rubbing material that comprises a basic material G inmixed with abrasion particles P. In this rendering, the rubbing element 11 has been formed in a layered manner although no layers 110 are visible. In other embodiments, the rubbing element 11 can also have only one layer and can be formed in a homogenous manner from the rubbing material.

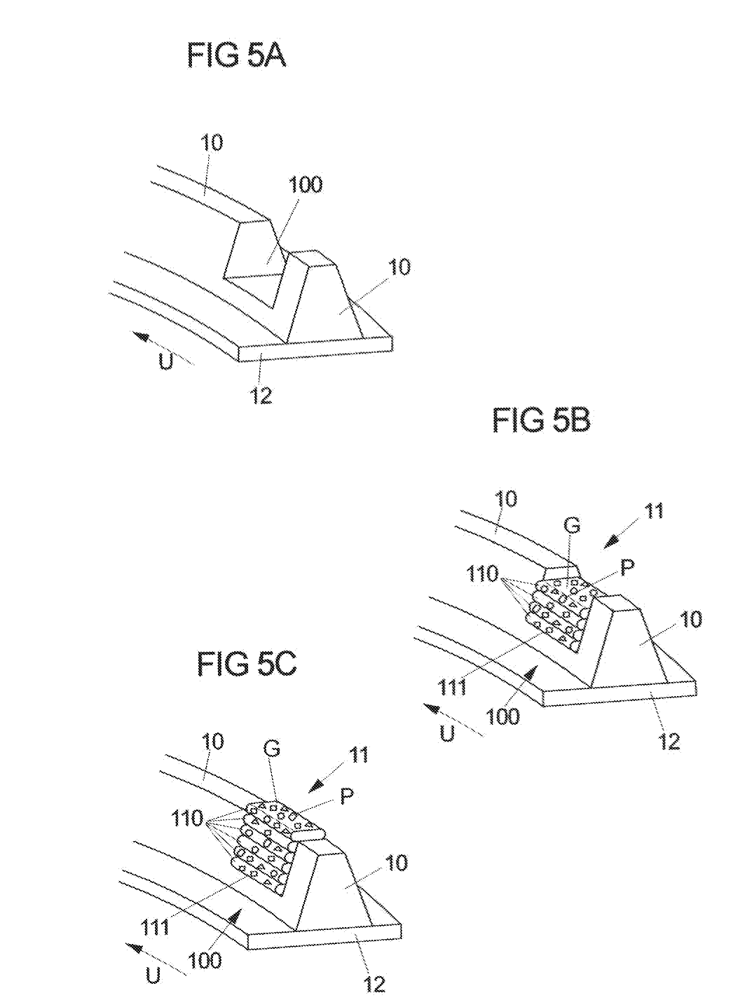

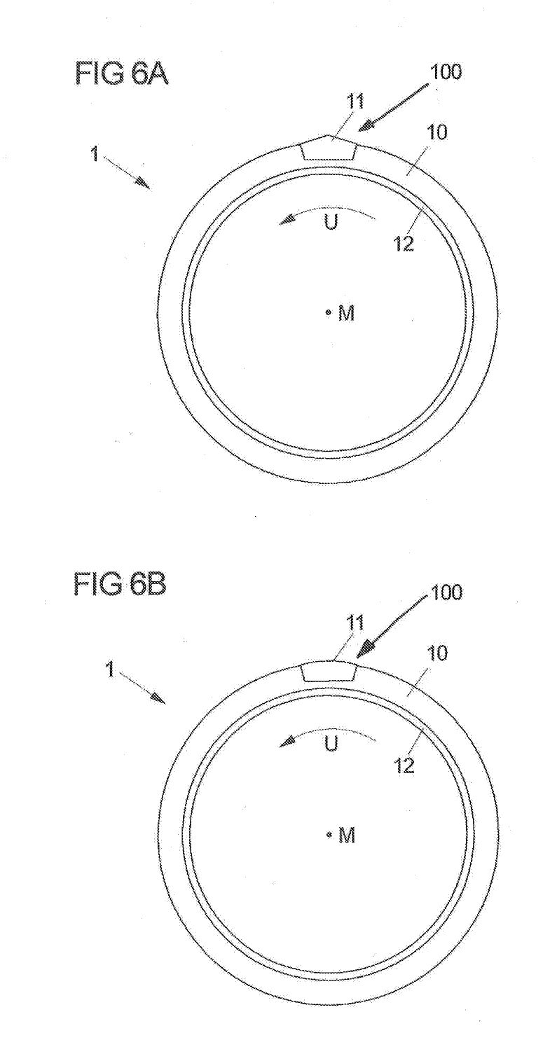

FIGS. 5A to 5C show a perspective view of a section of an embodiment variant of a sealing element 1, wherein the section shows the area of the sealing element 1 inside of which a recess 100 is located. Here, the three Figures show three different states during the formation of the rubbing element 11 at the sealing lip 10.

In this embodiment variant, the finished rubbing element 11 is formed in a layered manner inside the recess 100 of the sealing lip 10. The sealing lip 10 is connected to a base 12 of the sealing element 1.

What is shown in FIG. 5A is the state in which the recess 100 has already been introduced into the sealing lip 10, but no layers of the rubbing element 11 have yet been arranged inside the recess 100. FIG. 5C shows the state in which the rubbing element 11 is formed completely inside the recess 100. FIG. 5B shows an intermediate state between the states shown in FIGS. 5A and 5C, in which some layers of the rubbing element 11 have already been formed inside the recess 100, but the rubbing element 11 is not completely formed yet.

The layers of the rubbing element 11 are formed by layer-wise laser deposition welding of the rubbing material inside the recess 100. Here, the rubbing material comprises a basic material that is intermixed with abrasion particles P.

In a further embodiment that is not shown here, the rubbing element 11, which is formed layer-by-layer from the rubbing material, can also be formed inside a recess 100 that extends all the way up to the base 12 of the sealing element 1. Thus, the rubbing element 11 can also be connected directly to the base 12, since no material of the sealing lip 10 remains in the area of the recess 100.

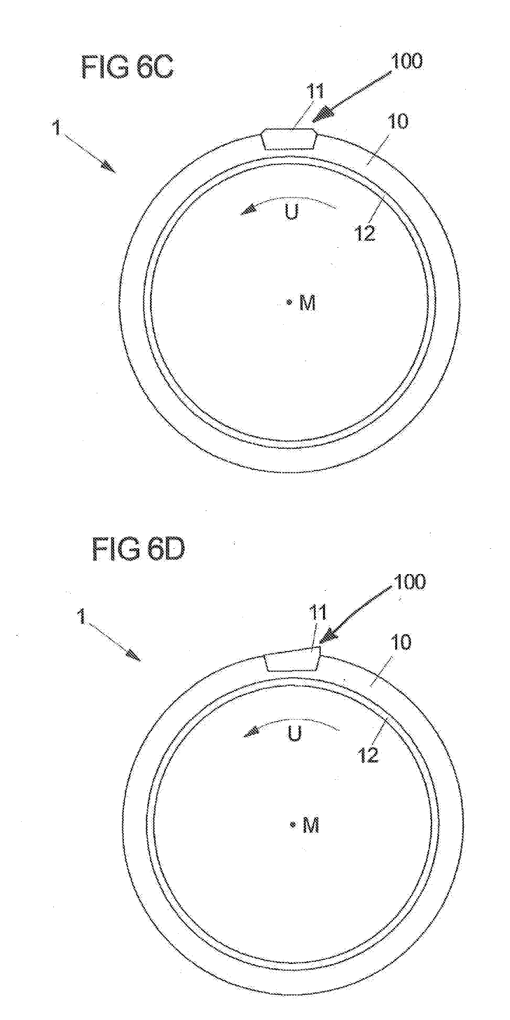

In FIGS. 6A to 6D, four different embodiment variants of a sealing element 1 are shown, which respectively differ from each other in the geometrical configuration of the at least one rubbing element 11. The four Figures respectively show the sealing element 1 in a cross-sectional plane perpendicular with respect to the rotational axis D.

In FIG. 6A, the rubbing element 11 has an isosceles, triangular contour in certain sections that projects in the radial direction beyond the outer contour of the sealing lip 10.

In FIG. 6B, the rubbing element 11 has an arc-shaped contour in certain sections that projects in the radial direction beyond the outer contour of the sealing lip 10.

In FIG. 6C, the rubbing element 11 has a trapezoid-shaped contour in certain sections that projects in the radial direction beyond the outer contour of the sealing lip 10.

In FIG. 6D, the rubbing element 11 has a triangular contour in certain sections that tapers off at an acute angle, wherein the smallest angle is located along the circumferential direction U at the front end. The radial extension of the rubbing element 11 increases counter to the circumferential direction U. In this manner, a kind of knife shape is created.

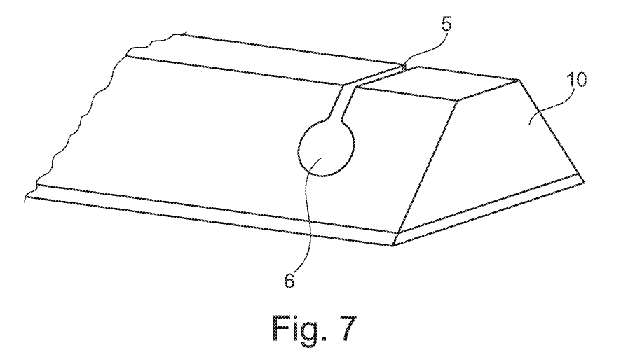

FIG. 7 shows a sealing lip 10 inside of which a slit-like groove 5 is arranged, which is arranged in a substantially radial manner. In the circumferential direction, the slit has a width of between 50 and 300 μm. In the radial direction, the groove extends across the entire height of the sealing lip 10.

A recess 6 is arranged at the base area of the groove 5, which can be configured as a bore, for example. In this way, a propagation of cracks can be prevented or minimized, among other things.

In the shown embodiment, the groove 5 is arranged in parallel to the rotational axis of the seal. In alternative embodiments, the orientation of the grooves 5 can also be configured so as to be tilted with respect to the rotational axis.

With a view to simplicity, only a single groove 5 is shown here, wherein in principle a plurality of such grooves 5 can be used. Here, the grooves 5 can be distributed along the circumference in a regular or also in an irregular manner.

It should be noted that the features of the individual described exemplary embodiments of the invention can be combined with each other.

### PARTS LIST

1 sealing element

5 groove, micro-slit

6 recess at the groove

10 sealing lip

10a side leg of the sealing lip

10b further side leg of the sealing lip

10c top side of the sealing lip

100 recess inside the sealing lip

11 rubbing element

110 layers of the rubbing element

111 separation layer

12 base

U circumferential direction

G basic material

P abrasion particles

M central point of the sealing lip

1. A sealing element for a rotating sealing system of a turbomachine, wherein, if installed in the sealing system according to the intended use, the sealing element can be rotated around a rotational axis of the turbomachine, with:
a ring-shaped sealing lip that has a central point through which the rotational axis extends if the sealing element is installed in the sealing system according to the intended use, wherein the sealing lip has at least one recess,
at least one rubbing element, which is arranged at the sealing lip, wherein the at least one rubbing element is arranged inside the at least one recess and projects at least partially beyond the outer contour of the sealing lip in the radial and/or the axial direction with respect to the rotational axis, wherein the at least one rubbing element has a plurality of layers of a rubbing material that comprises a basic material provided with abrasion particles,
wherein the axial extension of at least some layers of the at least one rubbing element decreases with growing distance from the central point, so that the at least one rubbing element at least in certain sections has a convergent outer contour in a cross-section perpendicular to the circumferential direction of the sealing element, and that the layers project axially beyond the outer contour of the sealing lip, so that the layers form a structure at the exterior side.

2. The sealing element according to at least claim 1, wherein the extension of at least some layers of the at least one rubbing element decrease along the circumferential direction with growing distance from the central point, so that the at least one rubbing element has a convergent outer contour in a cross-section perpendicular to the axial direction at least in certain sections.

3. The sealing element according to claim 1, wherein the at least one rubbing element has a separation layer for connecting to the sealing lip in order to facilitate the separation of the rubbing element from the sealing lip.

4. The sealing element according to claim 1, wherein the at least one rubbing element has a varying height along the circumferential direction of the sealing lip.

5. The sealing element according to claim 1, wherein the at least one rubbing element projects in the axial direction at least partially beyond the outer contour of the sealing lip only on one side of the sealing lip.

6. The sealing element according to claim 1, wherein the surface of the at least one rubbing element is not subjected to any further processing after having been arranged at the sealing lip.

7. The sealing element according to claim 1, wherein the at least one rubbing element is manufactured by means of laser deposition welding of the rubbing material.

8. The sealing element according to claim 1, wherein the basic material of the rubbing material is identical to the material of the sealing lip either to a substantial percentage or completely, and in particular is formed by a nickel-based alloy.

9. The sealing element according to claim 8, wherein the basic material have Inco718, Inco718+, Udimet, Waspaloy and/or RR1000 as the nickel-based alloy, or that they completely consist of these alloys.

10. The sealing element according to claim 1, wherein the abrasion particles are sharp-edged and/or have an increased hardness as compared to the basic material, and particularly in that they at least partially consist of metal, ceramics and/or carbide and comprise cBN and/or TiC particles.

11. The sealing element according to claim 1, wherein a plurality of recesses, in particular three or four, are arranged in a symmetrical manner along the circumference of the sealing lip, wherein a rubbing element is formed in every recess.

12. The sealing element according to claim 1, wherein, at its circumference, the sealing lip has a groove that is arranged at least in a substantially radial manner, in particular with grooves in the form of micro-slits having a width of between 50 μm and 300 μm.

13. A sealing system for a turbomachine, in particular a labyrinth seal, with at least one sealing element according to claim 1.

14. A sealing system according to claim 13, having a static run-in coating that is arranged opposite the at least one sealing element in the radial direction, so that during operation at least one rubbing element comes into contact with the static run-in coating and broaches the same at least partially.

15. A turbomachine, in particular an aircraft engine, with at least one sealing system according to claim 13.

16. A method for manufacturing a sealing element for a rotating sealing system of a turbomachine, in particular of a sealing element according to claim 1, comprising the following steps:
a) providing a sealing lip;
b) introducing at least one recess into the sealing lip, in particular by milling it out;
c) localized melting of the at least one recess, in particular by means of a laser;
d) introducing a powdery rubbing material that comprises a basic material intermixed with abrasion particles into the melted area of the recess and creating an area with an increased thickness;
e) repeating the steps c) and d) until a first layer of the at least one rubbing element that comprises the rubbing material is formed inside the at least one recess;
f) localized melting areas of an already formed layer of the at least one rubbing element, in particular by means of the laser;
g) introducing the powdery rubbing material into the melted area and in this way creating an area with an increased thickness;
h) repeating the steps f) and g) until another layer of the at least one rubbing element that comprises the rubbing material is formed inside the at least one recess;
i) repeating steps j) until the at least one rubbing element is built up from successive layers that comprise the rubbing material.
